(19) United States
(12) Patent Application Publication
(10) Pub. No.: US 2009/0232346 A1
(43) Pub. Date: Sep. 17, 2009

(54) METHOD FOR CAPTURING TEXT DATA AND/OR IMAGE DATA FOR PRODUCING IDENTIFICATION DOCUMENTS

(75) Inventor: Andre Zilch, Frankfurt/Main (DE)

Correspondence Address: DARBY & DARBY P.C., P.O. BOX 770, Church Street Station, New York, NY, 10008-0770, US

(73) Assignee: LSC LIFESCIENCE CONSULT GMBH, Eppstein (DE)

(21) Appl. No.: 11/718,088

(22) PCT Filed: Oct. 26, 2005
(86) PCT No.: PCT/EP05/11463

§ 371 Date: Apr. 26, 2007

(30) Foreign Application Priority Data
Oct. 26, 2004 (DE) 10 2004 052 117.4

(51) Int. Cl. G06K 9/00

(52) U.S. Cl. 382/100

(57) ABSTRACT

The method according to the invention is for capturing text data and/or image data for use in the production of identification documents for an applicant, e.g., a passport. The method involves recording electronic image data of the applicant by means of a suitable recording method, such as a digital camera. Further, electronic text data for this applicant is manually or automatically input to the record. Then an electronic set of data of the recorded image data and the input text data is produced. This set of data is signed by means of a qualified signature.

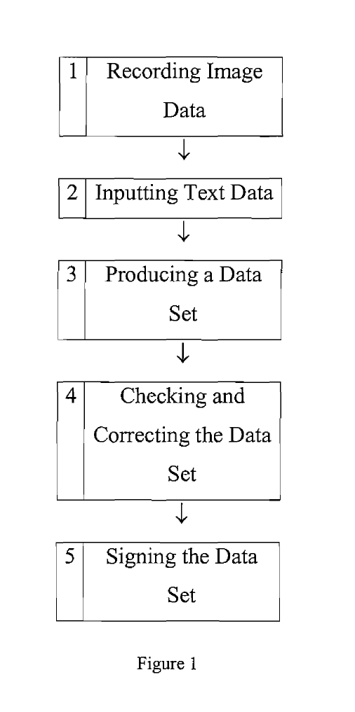

The invention relates to a method for capturing text data and/or image data for producing identification documents, including, for example, passports, identity cards, driver's licenses, chip cards, signature cards, electronic health records, debit and credit cards, and other proofs of identity, customer cards, passenger tickets, membership cards, personal entry cards, etc. Likewise, the method can also be used for capturing data for strictly electronic storage media, for which typically there is no paper and/or plastic and/or other part, which can be read by the naked eye without accessories. At the present time, examples of such storage media are storing integrated circuits, RFID storage media, etc. Such identification documents or storage media contain text data and/or image data, text data being, for example, the name, the date of birth, insurance data, customer numbers, etc. and/or describe the function of the applicant (such as physician, department manager or the like), and/or the purpose of the identification document (such as passenger ticket, boarding pass) and/or the authorization associated with the proof of identity (such as driver's license for passenger cars and/or trucks, extend of the insurance coverage) and image data being, for example, a passport photograph, a signature or other biometric data, such as a fingerprint or a picture of the iris.

The definitions given above of an “identification document”, “storage medium”, “image data” and “text data” also applied to the subsequent sections. The method is also transferable to identification documents for animals (such as insurance cards, pedigree documents, RFID chips) and articles, especially goods, equipment and objects (such as reports of experts concerning works of art, jewelry).

The reliable introduction of photographs into identification documents, with checking the identity of an applicant and matching with text data (administrative data), is a requirement, which has been sought for a long time. A relatively expensive method for producing identification documents is described in the DE 195 08 249 C2.

The method predominately used for filing applications for identification documents is paper-based. A form is filled out by hand by the applicant and a picture is affixed (mostly glued, hardly ever stapled). However, this method is not adequate, since the identity between the picture and the applicant cannot be guaranteed. Until now, methods on the market for verifying an identity offer only to check the administrative data (and optionally to obtain a signature) and do not check whether the picture or the signature is that of the applicant. With that, however, the requirements of the Signature Law with regard to the identity of pictures on signature cards are not taken into account. The requirements with regard to the identity of pictures on the identification cards of the medical profession, electronic health records etc. are also not satisfied by these paper-based methods.

If application forms, which are already filled out in advance with administrative data, are made available to the applicant, they may have to be revised manually by the applicant. However, the risk is increased here that, much like an application form filled completely out by hand, errors occur during a scanning process of the application form and the subsequent processing of the administrative data by ICR software (Intelligent Character Recognition software for the recognition of handwritten text, in contrast to OCR method for the recognition of machine-produced texts) and that these errors cannot be corrected by the issuer of the identity card. Pictures of deficient quality can also be optimized only in relation to contrast, coloring and picture size, but in relation to the selection of the subject.

A further possibility for introducing a photographic image or picture into an identification card consists therein that the future card holder goes to a suitable photographer or photographic copying place (such as an automatic photo-copying machine), has a picture made there, selects a suitable picture and then either brings this picture himself to the office issuing the identification document or sends the picture by post or even by e-mail. In the final analysis, none of these measures satisfies in any way the quality and identity requirements, relevant for data protection. The same holds true also for other electronically recorded biometric data.

For all of the identification documents named above, it is necessary to affix a photographic image of the holder on the identification document. Likewise, pictures and/or other biometric distinguishing features can be filed in the chip of the identification document. This means that the future user of an identification document of any type does not have to go either to a production office, a photographer or an automatic photograph-copying machine, where his picture is produced, and previously or subsequently have his identity and administrative information checked.

However, the identity of the picture is not checked here. The assurance of the identity of the picture, which is not free of doubt, the quality of the picture, as well as the identity of the administrative information in combination with the picture are some of the disadvantages of the process described.

At the present time, there is no method, which makes it possible, aside from checking the identity reliably, also to reliably check the picture and, subsequently, reliably transfer the identification data and the picture to a central office. It should be stated that it is a further disadvantage of the method described that an error can be recognized only late in the process chain, that is, immediately before the identification document is produced. A picture of the wrong size or lacking in quality leads to clearly higher process costs as well as to a loss of time, since it must be corrected in order to improve the quality and such collections are expensive. In the negative case, the process must be terminated since, because of the selection of motif, it cannot be corrected manually.

The question of the identity of the person shown in the picture remains unanswered completely. This checking cannot be carried out by a central office for producing the identification documents only by means of the picture. Analogously, this is also the case for other electronically recorded biometric distinguishing features (such as a fingerprint or an iris scan).

For all conventional methods, including the sources of error contained therein and the manipulation possibilities, the duration of the whole of the process, until the identification document is banded over to the holder, is completely inadequate especially for an area-wide issue.

Decentralized systems, which are able to carry out all intermediate processing steps, from making the picture up to producing the identification document, are extremely expensive and generally also require a well-trained personnel, which, moreover, must be entrusted with work of a different type, when their time is not utilized fully otherwise. Furthermore, for such methods, it has not been described how the manipulation-proof and legally binding, permanent, comprehensible, free of doubt assignment between the identity of the applicant, the text data and the image date is to be ensured.

A plurality of documents and publications is known, which are concerned with different aspects of producing identification cards or cards, having pictures. However, they are focused on the strictly technical method of introducing the picture into the laminate up to the printout with the help of a suitable medium.

For example, the JP 5-290063 A discloses a method for producing identity cards in the conventional card format. The future card holder goes to a photography office, where he is photographed with the help of a video camera. The identification data are likewise captured with a further video camera, in order then to be forwarded, together with the picture data, to a card-preparing office.

U.S. Pat. No. 4,678,526 (Wilfert) proposes that a picture be taken with a video camera, converted into a digital data sequence and reproduced on a screen. Other data, which is also supplied to a screen by way of a video camera and to which, with the help of a keyboard, supplementary treatments and data can also be added, can then also be treated similarly. Subsequently, the data reaches a laser printer, which prints out the portrait obtained and the other data on a sheet of paper. This sheet of paper is then brought between two layers of a transparent thermoplastic material and laminated with these layers under the action of heat and pressure.

The known methods and possibilities for producing identification documents having image data are not suitable for producing cost-effective identification documents, for which a forgery proof and unambiguous assignment of text data and image data to a certain person is assured.

It is therefore an object of the invention to indicate a method for capturing text data and image data for preparing identification documents, which ensures, without doubt, in a manipulation-proof, legally binding, permanent and comprehensible manner the correspondence of the text and image information contained therein with the personal data and/or the identity of the applicant.

This objective is accomplished by a method with the following steps:
recording image data of a person by means of a suitable recording method (such as a digital camera for passport photographs and/or an iris scanner for a picture of the iris and/or a touch screen for the signature, etc.)
inputting text data for this person by means of a suitable manual or automatic method (such as reading the identity card, reading in the information stored on the health insurance card)
producing a set of data of the recorded image data and the inputted text data
having the set of data signed by the recording personnel by means of a qualified signature.

Further advantageous steps of the method are described in claims 2 to 10.

The inventive method has the advantage that the image data and/or the text data, required for the respective identification document, are imported into a data processing device and verified and that this data is combined into a data set usually when the application is made. This is done under the supervision of appropriately trained and/or certified recording personnel, so that, for example, photographs are produced in high-quality and in the correct format with the correct image section. The data set, so obtained, is then signed by the recording personnel. All further steps, required for producing the identification document, can be carried out without involving the applicant.

The present invention relates mainly to a method for furnishing persons with identification documents, which contain image data and/or text data, yet are subject to high requirements with regard to ensuring identity and authenticity.

The inventive method opens up a path here for optimizing also the process chain for producing personal identification papers for passports, which was previously dependent on a physical photographic picture of the applicant, by means of modern electronic methods while observing the security requirements.

In view of the requirements of the Signature Law, the possibility of printing out the complete data set, obtained on site, and having it signed by the applicant is particularly advantageous. The signed data set can then be stored in a known manner, preferably by electronic means and provided with an electronic signature by the recording personnel. In this way, the inventive method also satisfies the highest requirements with regard to the authenticity of the future holder or the identification document and the legal security. The signed paper document may also subsequently be archived.

Accordingly, in this way, identification documents can be produced with a picture, signature and/or other biometric distinguishing features of high quality in relation to the photographic picture, biometric data, signature and administrative data, with great assurance in regard to the identity between the applicant and the electronic data set. A later manual correction or selection of photographic pictures or other image data of lower quality (contrast, size, choice of motif, sharpness, resolution) or a subsequent reissuing because of a wrong selection of motif, insufficient biometric distinguishing features or wrong administrative data, can be omitted.

Further advantages over paper-based applications are the shortened time from the recording of the data on site up to the issuing of the identification documents, as well as the complete omission of the scanning process for text data and image data. Difficulties of an ICR processing of manually produced application forms are avoided here (among other things, questions with regard to the pictures mailed in . . . ).

The further steps, required for producing the identification documents, can be carried out in the manner known. These include, for example, the, if necessary, coded transfer of the data set to the office issuing the identification document, where the documents transferred are, if necessary, decoded, if necessary, supplemented by further data and supplied to the Production Department.

The basic concept of the present invention consists therein that, during the production of identification documents,
1. a replacement is created for paper-based application forms with mounted photographic pictures by a method, which is largely electronic from the very start;
2. the identity of the applicant in relation to the text data (administrative data) and the image data (photographic picture, other biometric distinguishing features, signature) is assured and
3. the data set, produced from the text and image data, is compared by the person, instructed to do so by the office issuing the identification document, with the identity of the applicant and can be protected against forgery by an electronic signature.

The data set, so produced, can then be passed on in coded form, for example, to a central office issuing the identification document. From there, the coded data can be transferred to the preparer or organization entrusted with producing the identification documents, who decodes the data and produces the corresponding identification documents. In contrast to the previously received data, this identification document, prepared by the producer of identification documents, then represents a material object, which can be handed out to the applicant very quickly. An implantation or implementation is indicated, depending on the nature and recipient of the identification documents.

The advantages, which arise from such a method, are not restricted only to reducing process times and, with that, to decreasing costs. Rather, all types of identification documents with a photographic picture, signature and/or other biometric data of the holder, can be produced quickly and reliably with this method with checking of the identity of the applicant.

A preferred variation of the inventive method is described in greater detail in the following by means of a single FIGURE.

In a first step, for example, the image data of an applicant is recorded by means of a suitable recording method by the person instructed to do so by the office issuing the identification documents.

This is done, for example, by means of a digital camera for producing an electronic passport photograph and/or by means of an iris scanner for recording an electronic image of the iris, and/or

by means of a touch screen for producing an electronic copy of the manual signature,
and/or a fingerprint scanner for producing an electronic copy of the fingerprint of the applicant.

As an additional identifying characteristic of the image, the image data may, however, also contain an electronic image of an official identification document (identity card, passport).

In a second step, text data (name, date of birth, etc.) of this applicant are inputted by means of a suitable method. This is done, for example, by reading the identity card of the applicant with a reading device for reading the information, stored on the medical insurance card of the applicant or the like.

In a third step, an electronic data set is produced from the image data recorded and the text data inputted.

In a fourth step, the data set is checked by the authorized agent, for example, by comparing the data with corresponding official identification papers or documents of the applicant and, if necessary, corrected and amended.

In a fifth step, the data set is signed, preferably electronically, by the authorized agent by means of a qualified signature.

For a different variation of the inventive method, at least a portion of the image and text data is recorded by reading an identification, which is already in the possession of the applicant and which contains the desired information already in electronic form.

For a further variation of the inventive method, the data set is signed by the applicant and not by the authorized agent, in the event that the applicant already has a signature card.

The recording of the data is concluded by means of the electronic signing, in which the applicant must participate in some way or another. The office, issuing the identification document, can add further information to the signed data set, such as an identity card number or a new health insurance number, before the identification document is produced in a manner known. The signed data set is forwarded to a central office and/or a card producer, if necessary, in coded form.

In order to meet the requirements of the Signature Law for requesting an electronic signature, the electronic data set can be put out, for example, and printed in an additional step and the printout can be signed personally by the applicant and preferably also under the supervision of the authorized agent and scanned once again on site. The signed data set, so generated, can then also be signed electronically by the authorized agent and stored electronically. However, the signed data set can also be signed by the applicant himself in the event that the latter already has a signature card.

1. A method for capturing text data and/or image data for producing identification documents for an applicant with the following steps:
recording electronic image data of the applicant by means of a suitable recording method;
inputting electronic text data for this applicant by means of a suitable manual or automatic method;
producing an electronic set of data of the recorded image data and the inputted text data and
having the set of data signed by means of a qualified signature.

2. The method of claim 1, further including the following additional steps:
checking and, if necessary, correcting the data set before the latter is signed.

3. The method of claim 1, further including the following additional steps:
issuing the data set produced and having the issued data set signed digitally or manually by the applicant in addition to or instead of the qualified signature.

4. The method of according to claim 1, wherein the data set is signed electronically and/or stored electronically.

5. The method of claim 1, further including the following additional step:
transmitting the signed data set, if necessary, in coded form, for example, to the institution and/or to a producer of identification documents, issuing the identification document.

6. The method according to claim 1, wherein the signed data set is stored electronically and/or physically.

7. The method of claim 6, further including the following additional steps:
use of the data set for producing the identification document and for issuing the identification document to the applicant.

8. The method according to claim 1, wherein the text data and/or the image data is read in partly or completely by means of a reading device for already existing identification documents of the applicant.

9. The method according to claim 1, wherein the data set is signed by the applicant, in the event that the latter already has a signature card.

10. The method of according to claim 1, wherein the image data, as an additional identifying image characteristic, contains a copy of an official identification document (identification paper, passport).

11. The method of claim 2, further including the following additional steps:
issuing the data set produced and having the issued data set signed digitally or manually by the applicant.

12. The method according to claim 2, wherein the data set is signed electronically and/or stored electronically.

13. The method according to claim 3, wherein the data set is signed electronically and/or stored electronically.
